(19) United States
(12) Patent Application Publication
(10) Pub. No.: US 2026/0134562 A1
(43) Pub. Date: May 14, 2026

(54) THICKNESS MEASUREMENT APPARATUS AND METHOD FOR LARGE MOLDED PRODUCT

(71) Applicant: ELECTRONICS AND TELECOMMUNICATIONS RESEARCH INSTITUTE, Daejeon (KR)

(72) Inventors: Chang Beom KIM, Daejeon (KR); Yong Kwi Lee, Daejeon (KR); Hyun Chul Kang, Daejeon (KR); Sang Kyu Lim, Daejeon (KR)

(21) Appl. No.: 19/382,640

(22) Filed: Nov. 7, 2025

(30) Foreign Application Priority Data
Nov. 8, 2024 (KR) 10-2024-0158484
Apr. 1, 2025 (KR) 10-2025-0042316

(51) Int. Cl. G06T 7/60; G01B 11/06; G06T 7/11; G06T 7/136

(52) U.S. Cl. CPC G06T 7/60; G01B 11/06; G06T 7/11; G06T 7/136; G06T 2207/10024; G06T 2207/20132; G06T 2207/30108

(57) ABSTRACT

The present invention relates to a thickness measurement apparatus and method for a large molded product, and the thickness measurement apparatus for a large molded product includes a light source holder module which rotates a light source in 3-axis directions, a horizontal movement module which horizontally moves the light source holder module mounted on a horizontal movement guide, a vertical movement module which vertically moves the horizontal movement guide along a vertical movement guide, and a processor which moves the light source to a measurement position by operating the horizontal movement module, the vertical movement module, and the light source holder module according to a measurement schedule based on the measurement position of a molded product, operates the light source, obtains a transmitted light image from a measurement surface using a camera, and calculates a thickness at the measurement position from an image obtained by preprocessing the transmitted light image.

### CROSS-REFERENCE TO RELATED APPLICATIONS

This application claims priority to and the benefit of Korean Patent Application No. 10-2024-0158484, filed on Nov. 8, 2024, and Korean Patent Application No. 10-2025-0042316, filed on Apr. 1, 2025, the disclosures of which are incorporated herein by reference in its entirety.

### BACKGROUND

### 1. Field of the Invention

The present invention relates to a thickness measurement apparatus and method for a large molded product which measures a thickness of a large molded product formed of a light-transmitting material.

### 2. Discussion of Related Art

In general, large molded products are manufactured using vacuum molding, injection molding, and the like and used in various industrial fields such as refrigerator inner boxes, vehicle interior parts, aircraft parts, and the like.

The thickness of such a product is an important factor for determining insulation performance, durability, structural strength, etc., and the thickness of a large molded product is mainly measured through a manual method or a sampling measurement method, which causes various problems.

A manual measurement method is performed using a micrometer or vernier calipers and provides high accuracy but has disadvantages that a measurement time is long and fatigability of a worker increases due to repeated work. In addition, there is a high possibility of a measurement error occurring in a manual measurement process, and it is difficult to maintain a uniform quality standard. Particularly, in the case of a large molded product, since it is difficult to measure the thickness of the entire large molded product, a portion thereof is cut and measured, and thus damage to the product is inevitable.

In addition, a non-contact ultrasonic thickness measurement method is applied to some processes. Such an ultrasonic method is convenient because the thickness of an inner box is measured in a non-contact method, but there is a high possibility of an error occurring in a portion in which there are too many curved surfaces or of which a shape is too complex when inspection is performed on a large area. Such an ultrasonic method has advantages that a measurement time is relatively short, and the measurement is performed in the non-contact method, but it is difficult to perform high-precision measurement, and thus there is a limitation that the ultrasonic method is used only as a sampling inspection method.

Meanwhile, there is a precision inspection method using a three-dimensional (3D) scanner and a computerized tomography (CT) inspection apparatus, and such an apparatus provides high precision. However, since an inspection cost of the precision inspection method is high, and a measurement time thereof is long, it is difficult to apply the precision inspection method to a mass production process, and thus the precision inspection method is partially applied in a research and development department or applied to verify quality but is practically difficult to apply to a production site in real time.

Time taken in a process of measuring a thickness in a large molded product manufacturing process varies according to a measurement method and a sampling frequency, and when a worker manually performs measurement, there is a big time difference according to the number of measurement points and a complex shape of an inner box. In general, it takes 5 to 10 minutes to measure one sample. In addition, although an ultrasonic measurement apparatus may perform measurement slightly faster than manual measurement, it takes about 3 to 8 minutes per sample which includes preparation time and measurement apparatus setting time, and in this case, time may increase when the measurement is performed multiple times for accuracy.

Accordingly, a sampling frequency at which a thickness is measured in a large molded product manufacturing process varies according to a production line, and in general, there are many cases where 1 to 2 samples are selected and measured.

Since an error may occur in a manual measurement method as described above, and it is difficult to secure consistent quality, the introduction of a measurement apparatus which is precise and is applied to a production line is essential in order to automate the thickness measurement of a large molded product and manage quality in real time.

To this end, a high-precision automatic measurement system capable of performing sequential real-time measurement and minimizing measurement errors in products formed of various materials and having various shapes is required. In addition, the high-precision automatic measurement system should provide a fast measurement speed and perform non-contact and non-destructive measurement to prevent product damage in order to be directly applied to a manufacturing process.

### SUMMARY OF THE INVENTION

A technical object of the present invention is to provide a thickness measurement apparatus for a large molded product, which measures a thickness of a large molded product formed of a light-transmitting material, and a method thereof.

However, technical objects to be achieved through the present invention are not limited to the above-described technical object, and other technical objects that are not described above will be clearly understood by those skilled in the art from the following description of the invention.

A thickness measurement apparatus for a large molded product according to one aspect of the present invention includes a light source holder module which rotates a light source in 3-axis directions, a horizontal movement module which horizontally moves the light source holder module mounted on a horizontal movement guide, a vertical movement module which vertically moves the horizontal movement guide along a vertical movement guide, and a processor which moves the light source to a measurement position by operating the horizontal movement module, the vertical movement module, and the light source holder module according to a measurement schedule based on the measurement position of a molded product, operates the light source, obtains a transmitted light image from a measurement surface using a camera, and calculates a thickness at the measurement position from an image obtained by preprocessing the transmitted light image.

In the present invention, the processor may rotate the camera toward the measurement surface using a camera rotation module and obtain the transmitted light image of red-green-blue (RGB).

In the present invention, the processor may preprocess the transmitted light image by cropping an image of a set region in the transmitted light image based on the measurement position, converting the image to a grey image, converting the grey image to a black and white binary image based on a set threshold value, obtaining a centroid of a white area in the binary image, and cropping the image based on the centroid.

In the present invention, the processor may calculate the thickness at the measurement position by converting the number of pixels of the white area using a thickness conversion function.

In the present invention, the processor may set a correction factor of the thickness conversion function to vary according to an amount of light of the light source.

In the present invention, the thickness measurement apparatus may further include a fixing module of which a width and a height are adjusted and fixed to fix the molded product in a region between the horizontal movement guide and the vertical movement guide.

A thickness measurement method for a large molded product according to another aspect of the present invention includes operating, by a processor, a horizontal movement module, a vertical movement module, and a light source holder module according to a measurement schedule based on a measurement position of a molded product, moving a light source to the measurement position, and operating the light source, obtaining, by the processor, a transmitted light image from a measurement surface using a camera, preprocessing, by the processor, the transmitted light image, and calculating, by the processor, a thickness at the measurement position from the preprocessed image.

In the present invention, the obtaining of the transmitted light image may include rotating, by the processor, the camera toward the measurement surface using a camera rotation module and obtaining the transmitted light image of RGB.

In the present invention, the preprocessing may include converting, by the processor, the transmitted light image to a grey image by cropping an image of a set region of the transmitted light image based on the measurement position, converting, by the processor, the grey image to a black and white binary image based on a set threshold value, and obtaining, by the processor, a centroid of a white area of the binary image and cropping the binary image based on the centroid.

In the present invention, the calculating of the thickness may include calculating, by the processor, the thickness at the measurement position by calculating the number of pixels of the white area in the binary image and using a thickness conversion function.

In the present invention, the calculating of the thickness may include setting, by the processor, a correction factor of the thickness conversion function to vary according to an amount of light of the light source.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram illustrating a thickness measurement apparatus for a large molded product according to one embodiment of the present invention;

FIG. 2 is an exemplary view illustrating an entire configuration of the thickness measurement apparatus for a large molded product according to one embodiment of the present invention;

FIG. 3 is a configuration diagram specifically illustrating a light source holder module in the thickness measurement apparatus for a large molded product according to one embodiment of the present invention;

FIG. 4 is a configuration diagram specifically illustrating a horizontal movement module in the thickness measurement apparatus for a large molded product according to one embodiment of the present invention;

FIG. 5 is a configuration diagram specifically illustrating a vertical movement module in the thickness measurement apparatus for a large molded product according to one embodiment of the present invention;

FIG. 6 is a configuration diagram illustrating an emission state of a light source in the thickness measurement apparatus for a large molded product according to one embodiment of the present invention;

FIG. 7 is an exemplary view illustrating an operation state of a camera rotation module in the thickness measurement apparatus for a large molded product according to one embodiment of the present invention;

FIG. 8 is an exemplary view illustrating a state in which a molded product is fixed to a fixing module in the thickness measurement apparatus for a large molded product according to one embodiment of the present invention;

FIG. 9 is an exemplary screen showing an execution result of the thickness measurement apparatus for a large molded product according to one embodiment of the present invention;

FIG. 10 is an exemplary view showing a cropped image of a transmission region in the thickness measurement apparatus for a large molded product according to one embodiment of the present invention;

FIG. 11 is an exemplary view showing a state in which the cropped image is converted to a grey image in the thickness measurement apparatus for a large molded product according to one embodiment of the present invention;

FIG. 12 is an exemplary view illustrating a state in which the grey image is converted to a binary image in the thickness measurement apparatus for a large molded product according to one embodiment of the present invention; and

FIG. 13 is a flowchart for describing a thickness measurement method for a large molded product according to one embodiment of the present invention.

### DETAILED DESCRIPTION OF EXEMPLARY EMBODIMENTS

Hereinafter, examples of a thickness measurement apparatus and method for a large molded product according to embodiments of the present invention will be described.

Thicknesses of lines or sizes of components illustrated in the accompanying drawings may be exaggerated for clarity and convenience of description. In addition, terms described below are defined in consideration of functions in the present invention, and meanings of the terms may vary depending on, for example, a user or operator's intentions or customs. Therefore, the terms should be defined based on the content throughout this specification.

Hereinafter, embodiments of the present invention will be described in detail with reference to the accompanying drawings in order for those skilled in the art to easily perform the present invention. However, the present invention may be implemented in several different forms and is not limited to the embodiments described herein. In addition, parts irrelevant to description are omitted in the drawings in order to clearly describe the present invention, and the same or similar parts are denoted by the same reference numerals throughout this specification.

Throughout this specification, when a certain part “includes” a certain component, other components are not excluded unless explicitly described otherwise, and other components may further be included therein.

The present invention described in this specification can be implemented through, for example, a method, a process, an apparatus, a software program, a data stream, or a signal. Even when the present invention is described as being implemented in only a single form (for example, as a method), the described features may be implemented in another form (for example, as an apparatus or program). The apparatus may be implemented using proper hardware, software, firmware, etc. For example, the method may be implemented in an apparatus such as a processor or the like which is generally referred to as a processing device including a computer, a microprocessor, an integrated circuit, or a programmable logic device.

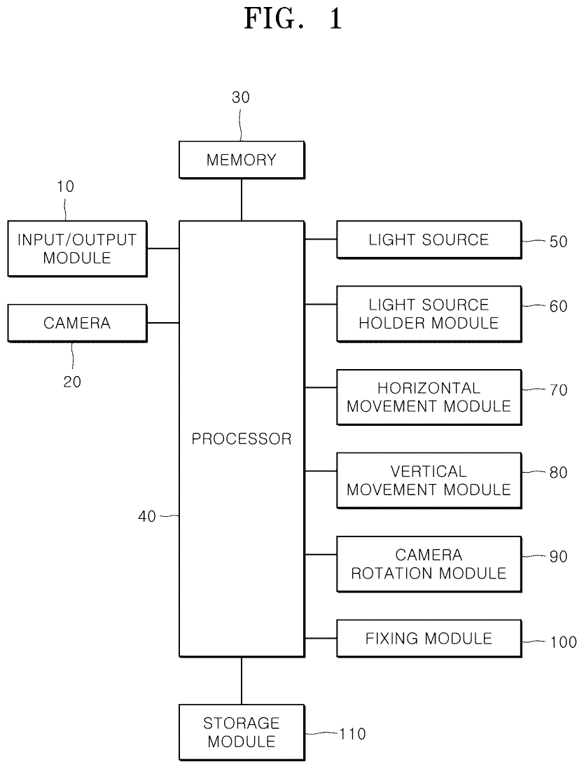

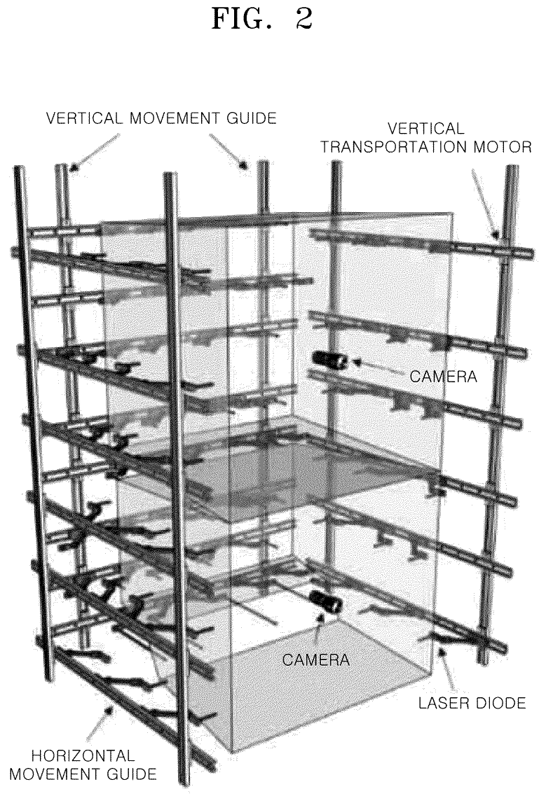

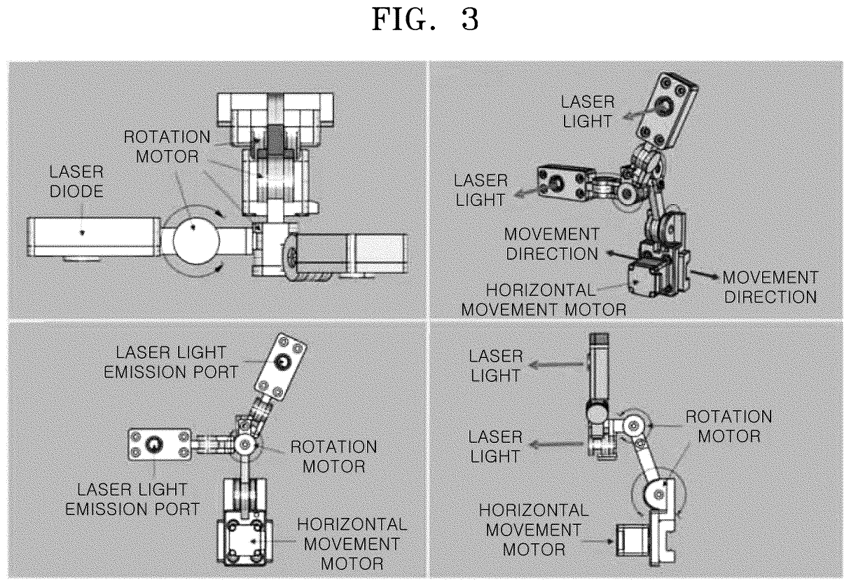

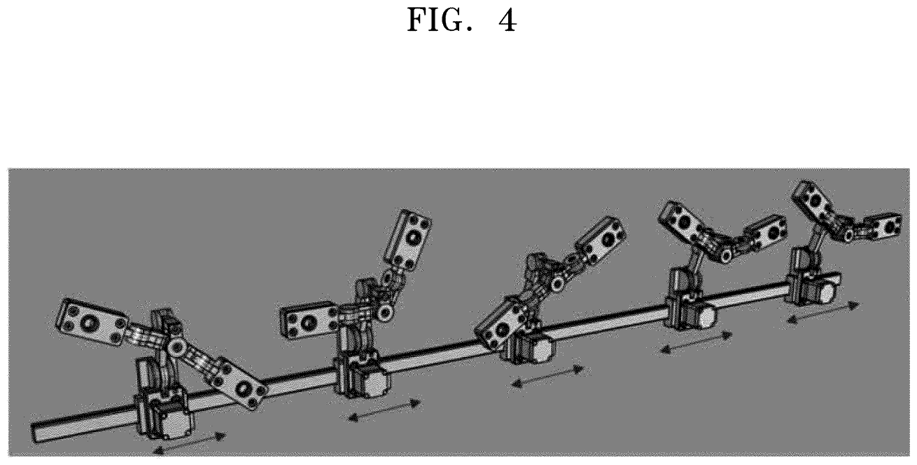

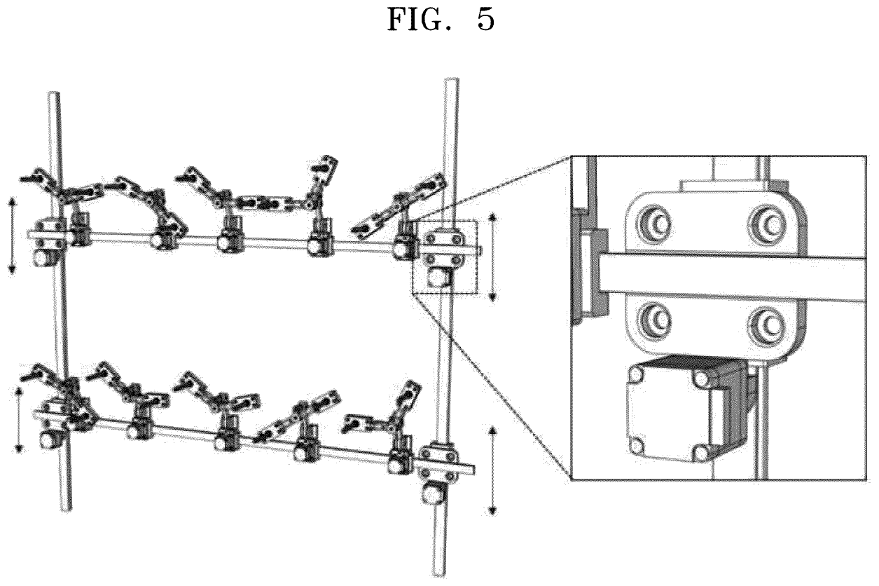

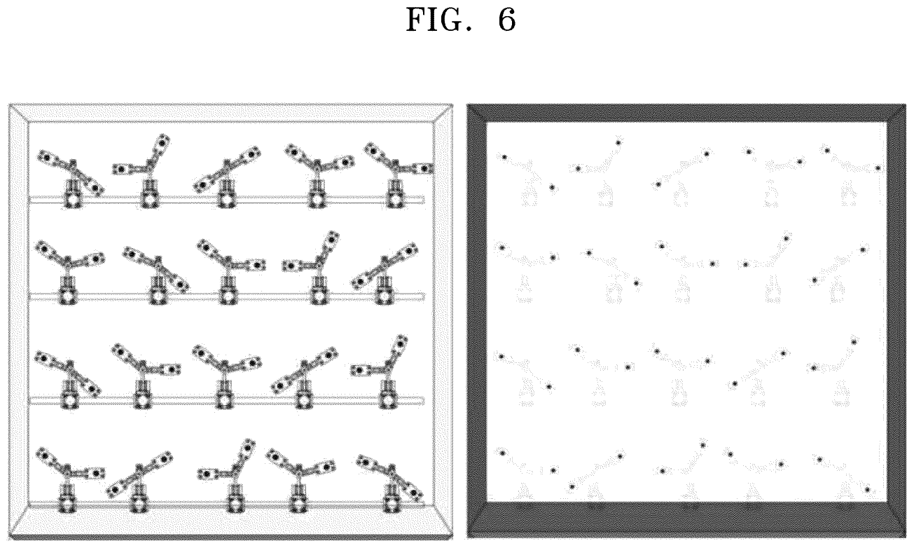

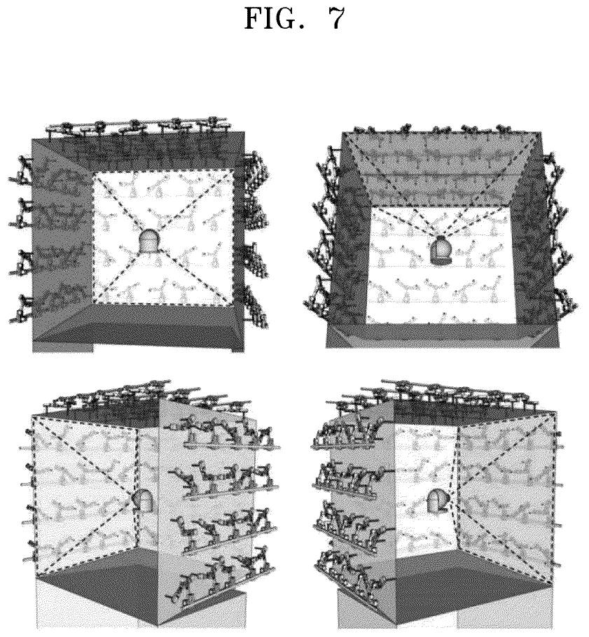

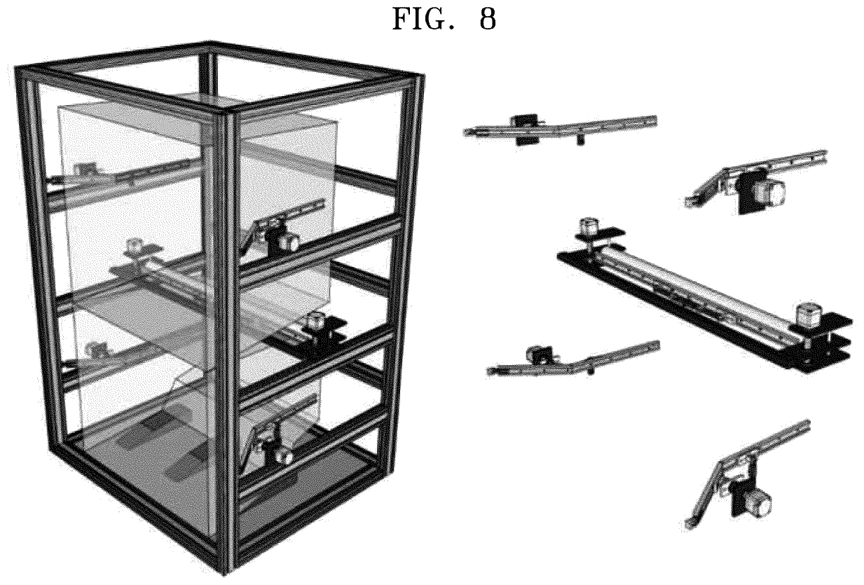

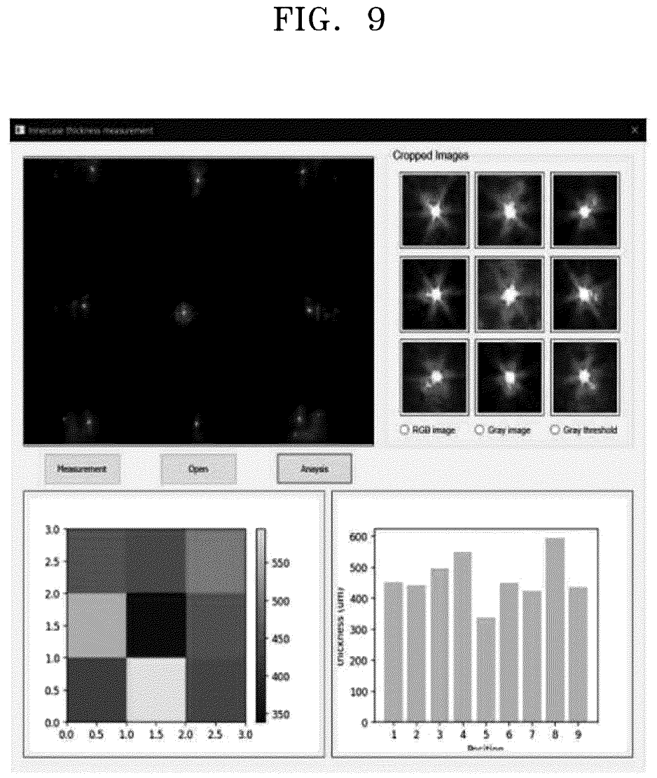

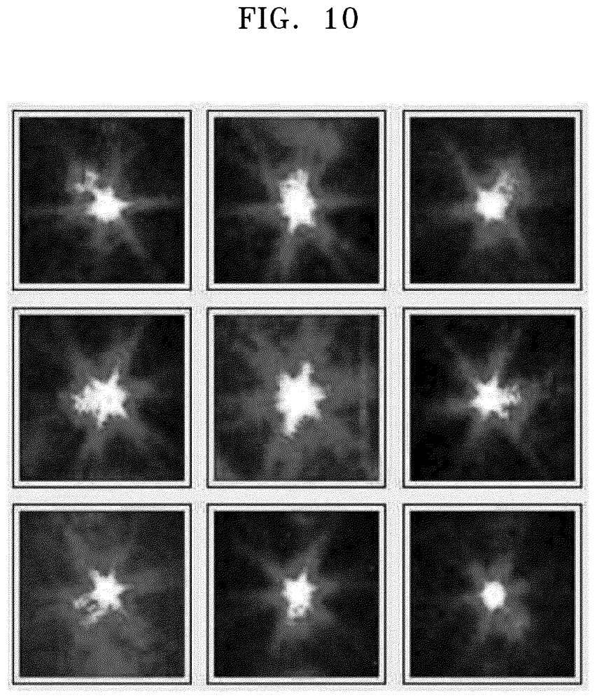

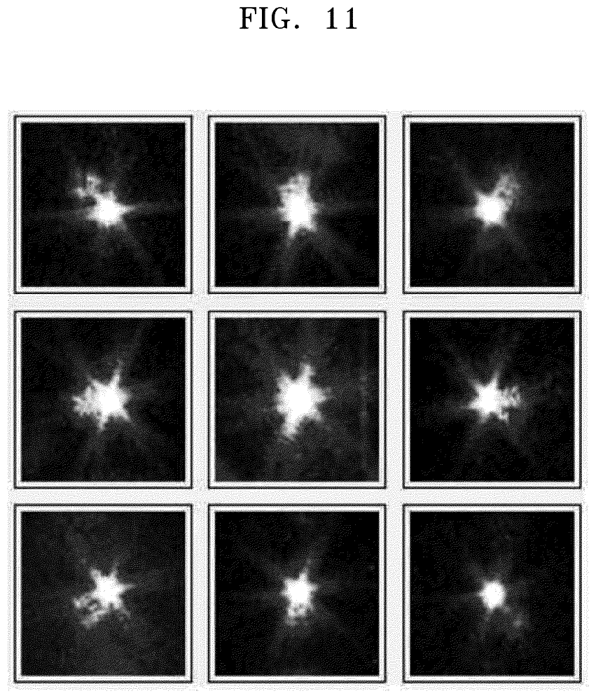

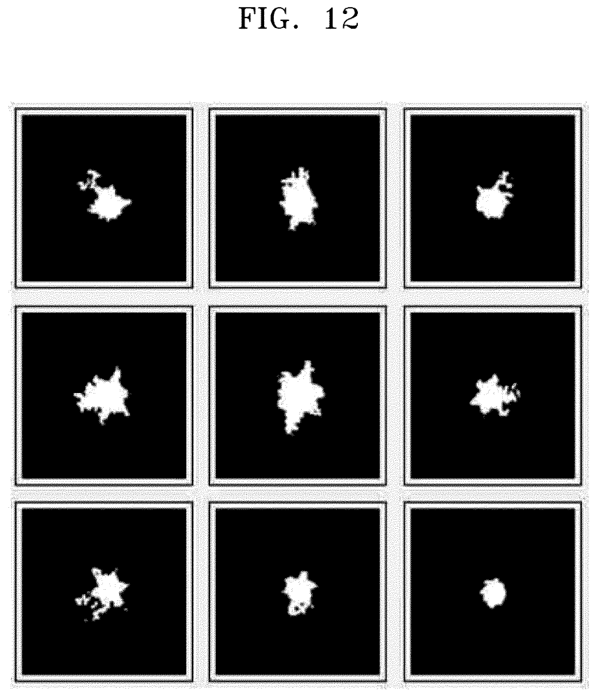

FIG. 1 is a block diagram illustrating a thickness measurement apparatus for a large molded product according to one embodiment of the present invention, and FIG. 2 is an exemplary view illustrating an entire configuration of the thickness measurement apparatus for a large molded product according to one embodiment of the present invention. FIG. 3 is a configuration diagram specifically illustrating a light source holder module in the thickness measurement apparatus for a large molded product according to one embodiment of the present invention. FIG. 4 is a configuration diagram specifically illustrating a horizontal movement module in the thickness measurement apparatus for a large molded product according to one embodiment of the present invention. FIG. 5 is a configuration diagram specifically illustrating a vertical movement module in the thickness measurement apparatus for a large molded product according to one embodiment of the present invention, and FIG. 6 is a configuration diagram illustrating an emission state of a light source in the thickness measurement apparatus for a large molded product according to one embodiment of the present invention. FIG. 7 is an exemplary view illustrating an operation state of a camera rotation module in the thickness measurement apparatus for a large molded product according to one embodiment of the present invention. FIG. 8 is an exemplary view illustrating a state in which a molded product is fixed to a fixing module in the thickness measurement apparatus for a large molded product according to one embodiment of the present invention. FIG. 9 is an exemplary screen showing an execution result of the thickness measurement apparatus for a large molded product according to one embodiment of the present invention, and FIG. 10 is an exemplary view showing a cropped image of a transmission region in the thickness measurement apparatus for a large molded product according to one embodiment of the present invention. FIG. 11 is an exemplary view showing a state in which the cropped image is converted to a grey image in the thickness measurement apparatus for a large molded product according to one embodiment of the present invention, and FIG. 12 is an exemplary view illustrating a state in which the grey image is converted to a binary image in the thickness measurement apparatus for a large molded product according to one embodiment of the present invention.

As illustrated in FIG. 1, the thickness measurement apparatus for a large molded product according to one embodiment of the present invention may include an input/output module 10, a camera 20, a memory 30, a processor 40, light sources 50, light source holder modules 60, horizontal movement modules 70, vertical movement modules 80, a camera rotation module 90, a fixing module 100, and a storage module 110.

The input/output module 10 may be a module for a user interface, through which a command for operation of the thickness measurement apparatus for a large molded product may be input and a measurement result may be output. In addition, a specification and a measurement position for thickness measurement of a molded product which is a measurement target may be input through a model name of the large molded product, a measurement schedule may be set, and a measurement button, an analysis button, a storage button, an opening button, and the like of an execution program for the thickness measurement may be manipulated.

For example, the input/output module 10 may include a device for input such as a mike, a keyboard, a mouse, etc., and a device for output such as a display, a speaker, etc. As another example, the input/output module 10 may also include a device in which functions for input and output are integrated in one device such as a touch screen. In addition, the input/output module 10 may be provided as one device such as a computer device.

The light sources 50 may generate light for measuring transmitted light by emitting the light to the light-transmitting molded product. In this case, each of the light sources 50 may include a laser diode, a light-emitting diode, or the like, and the present embodiment will be basically described using the laser diode.

The light source holder modules 60 may precisely move the light sources 50 to measurement positions in 3-axis directions. In this case, a plurality of light sources 50 may be attached to the light source holder modules 60.

That is, as illustrated in FIG. 3, the laser diode may be installed in each of the light source holder modules 60 to emit laser light through a laser light emission port, and the laser light emission port may be rotated in the 3-axis (x, y, and z axes) directions by driving rotation motors installed at each axis

In this case, as illustrated in FIGS. 2 and 4, a plurality of light source holder modules 60 may be mounted on horizontal movement guides.

The horizontal movement modules 70 may horizontally move the light source holder modules 60 mounted on the horizontal movement guides by driving horizontal movement motors.

As illustrated in FIGS. 2 and 5, the vertical movement modules 80 may vertically move the horizontal movement guides on which the light source holder modules 60 are mounted along vertical movement guides by driving vertical movement motors.

In this case, a plurality of horizontal movement guides may be disposed and moved on the vertical movement guides.

Accordingly, the light source holder modules 60 may be moved to measurement positions along the horizontal movement guides and the vertical movement guides by the horizontal movement modules 70 and the vertical movement modules 80, and as illustrated in FIG. 6, the laser diodes may be accurately moved to measurement positions for the product by driving the rotation motors of the light source holder modules 60 in order to emit the laser light.

A wide-angle lens may be mounted in the camera 20, and the camera 20 may obtain an image of transmitted light transmitted through a measurement surface of the product in one shot.

As illustrated in FIG. 7, the camera rotation module 90 may sequentially rotate the camera 20 to be directed to a measurement surface in the product to measure the transmitted light to allow the camera 20 to capture the transmitted light image.

Meanwhile, when a large molded product such as inner boxes of a refrigerator is positioned in a darkroom in order to obtain accurate transmitted light images of the large molded product, the fixing module 100 may automatically adjust a width and a height thereof, fixedly guide left and right surfaces thereof, and fixedly adjust a gap between upper and lower inner boxes according to a specification of the product based on a product model name to correspond to the large molded product such that the molded product is fixed in a region between the horizontal movement guides and the vertical movement guides.

The storage module 110 may store a transmitted light image obtained through the camera 20, a correction factor of a thickness conversion function, and a thickness measurement result.

The memory 30 may store the execution program and related data for the thickness measurement apparatus for a large molded product, and stored information may be selected by the processor 40 as necessary. In addition, the memory 30 may also store a specification and a measurement position of a large molded product based on the product model name.

That is, the memory 30 stores an operating system (O/S) for driving the thickness measurement apparatus for a large molded product, various types of data generated during an execution process of an application (process or applet), and commands. In this case, the memory 30 may be implemented as a non-volatile memory, a volatile memory, a flash-memory, a solid-state drive (SSD), etc. In addition, the memory 30 may be accessed, and data may be read/written/modified/deleted/updated, etc., by the processor 40.

The processor 40 may be operatively coupled to the input/output module 10, the camera 20, the memory 30, the light sources 50, the light source holder modules 60, the horizontal movement modules 70, the vertical movement modules 80, the camera rotation module 90, the fixing module 100, and the storage module 110, may copy various programs stored in the memory 30 to a random access memory (RAM), and may execute the programs to perform various operations to control overall operations of the thickness measurement apparatus for a large molded product.

In this case, it has been described that the processor 40 includes only one central processing unit (CPU), but the processor 40 may be implemented as a plurality of CPUs (or digital signal processors (DSPs), system on chips (SoCs), etc.) when implemented.

As various examples, the processor 40 may be implemented as a DSP which processes a digital signal, a microprocessor, or a time controller (TCON). However, the present invention is not limited thereto. The processor 40 may include one or more of a CPU, a micro controller unit (MCU), a micro processing unit (MPU), a controller, an application processor (AP), a communication processor (CP), and an ARM processor, or may be defined as a corresponding term. In addition, the processor 40 may be implemented in a type of SoC, large scale integration (LSI), or field programmable gate array (FPGA) in which a processing algorithm is stored.

That is, the processor 40 executes the execution program stored in the memory 30 and receives a product model name or a specification of a molded product and a measurement position for measuring a thickness through the input/output module 10. When the molded product of which the thickness is to be measured is fixedly installed in the darkroom, and thickness measurement starts, the processor 40 operates the horizontal movement modules 70 the vertical movement modules 80, and the light source holder modules 60 according to a schedule to move the light sources 50 to measurement positions and precisely adjusts and operates the light sources 50.

Then, the processor 40 may rotate the camera rotation module 90, obtain a transmitted light image from a measurement surface, calculate the number of pixels of a transmission region from an image obtained by preprocessing the transmitted light image, and calculate the thickness at the measurement position through a thickness conversion function for converting the number to the thickness.

That is, as illustrated in FIG. 9, a transmitted light image and a cropped image of a set region of a measurement position which are a result of measuring a thickness by obtaining the transmitted light image may be displayed on an execution screen, a thickness result value may be displayed as a graph in a two-dimensional (2d)-color map form and a quantitative bar chart form, and the result value including a model name, a measurement date and time, the measurement position, and the like may be output and stored in image, graph, and text forms.

Meanwhile, a red-green-blue (RGB) image may be extracted and reanalyzed using the opening button when data needs to be double checked later.

In a more specific process of calculating a thickness, the processor 40 may sequentially rotate the camera 20 toward a rear surface, a left surface, an upper surface, a lower surface, a right surface, etc., according to a measurement schedule and obtain transmitted light RGB images.

In this case, the processor 40 crops an image of a set region based on a measurement position at which a transmitted light image is obtained, stores the cropped image as illustrated in FIG. 10, and converts the cropped image to a grey image (0 to 255 px) by removing color information from the cropped image as illustrated in FIG. 11. Then, the processor 40 converts the grey image to a black and white binary image by setting pixels within a range of a threshold value to a white color of 255 px as illustrated in FIG. 12 and setting pixels out of the region of the threshold value to a black color of 0 px based on a set threshold value (for example, 100 px to 255 px).

Then, the processor 40 preprocesses the binary image by obtaining a centroid of a white area in the binary image, setting the centroid as a new reference point, and cropping the binary image based on the new reference point.

After the transmitted light image is preprocessed, the processor 40 may calculate a thickness at the measurement position by calculating the numbers of pixels of the white area in the binary image and converting the numbers to the thickness using the thickness conversion function.

In this case, the thickness conversion function may be defined as a combination of a power function form and an exponential function form like Equation 1.

$$y = {c}_{1} {x}^{{c}_{2}} + {c}_{3} {e}^{{c}_{4} x} \qquad [ Equation 1 ]$$

In this case, x is the number of pixels within a range of a threshold value, y is a thickness, and c1, c2, c3, and c4 are correction factors.

In this case, since an amount of transmitted light varies according to a thickness, the correction factors may be set by analyzing a transmitted light image (correct image) of a sample of which an exact thickness is known and calculating the number of pixels within a range of a threshold value.

Accordingly, the processor 40 may set the correction factors of the thickness conversion function differently according to an amount of light of the light source 50 to calculate a thickness.

As described above, according to the thickness measurement apparatus for a large molded product according to the embodiment of the present invention, since the light sources 50 may move to different positions according to a product model in horizontal and vertical directions, precisely move in the x, y, and z axis directions, and emit light, and the camera for obtaining a transmitted light image may rotate in various directions and capture an image, a thickness may be measured by automatically changing a position of a large molded product formed of a light-transmitting material having any of various sizes, obtaining a transmitted light image, and analyzing image data.

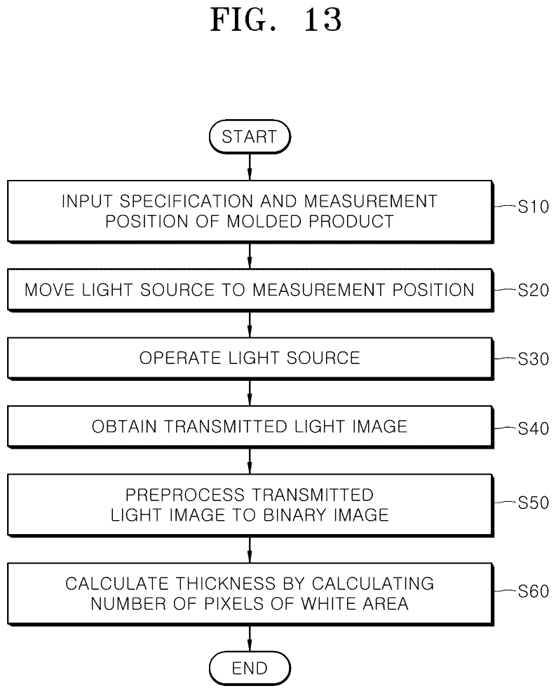

FIG. 13 is a flowchart for describing a thickness measurement method for a large molded product according to one embodiment of the present invention.

As illustrated in FIG. 13, in the thickness measurement method for a large molded product according to one embodiment of the present invention, first, the processor 40 drives the execution program stored in the memory 30 and receives a product model name or a specification of a molded product and a measurement position for measuring a thickness through the input/output module 10 (S10).

In this case, since the memory 30 stores information about the specification of the molded product corresponding to the product model name and the measurement position for measuring the thickness, when the product model name is input, the processor 40 may read and receive the specification of the molded product and the measurement position for measuring the thickness stored in the memory 30.

In addition, the molded product of which the thickness is to be measured may be positioned in the darkroom, and the processor 40 may drive the fixing module 100 to automatically adjust a width and a height thereof, fixedly guide left and right surfaces thereof, and fixedly adjust a gap between upper and lower inner boxes according to the specification of the product based on the product model name to correspond to the large molded product such that the molded product is fixed in a region between the horizontal movement guides and the vertical movement guides.

After the processor 40 receives the specification of the molded product and the measurement position in operation S10, the processor 40 moves the light sources 50 to measurement positions by operating the horizontal movement modules 70, the vertical movement modules 80, and the light source holder modules 60 according to a measurement schedule and performs precise adjustment (S20).

The processor 40 moves the light source holder modules 60 to the measurement positions along the horizontal movement guides and the vertical movement guides using the horizontal movement modules 70 and the vertical movement modules 80, and drives the rotation motors of the light source holder modules 60 to accurately move the light sources 50 to the measurement positions such that laser light is emitted as illustrated in FIG. 6. In the present embodiment, laser diodes are used as the light sources 50, but light of light-emitting diodes may be used.

After the processor 40 moves the light sources 50 to the measurement positions in operation S20, the processor 40 operates the light sources 50 to emit the laser light to the measurement position of the molded product (S30).

After the laser light is emitted in operation S30, the processor 40 rotates the camera rotation module 90 and obtains a transmitted light RGB image from a measurement surface in one shot using the camera 20 as illustrated in FIG. 9 (S40).

After the processor 40 obtains the transmitted light RGB image in operation S40, the processor 40 converts the transmitted light image to a binary image by preprocessing the transmitted light image (S50).

That is, the processor 40 converts the transmitted light image to a grey image by cropping an image of a set region in the transmitted light image based on the measurement position as a small image, storing the small image, and removing color information from the small image as illustrated in FIG. 11.

Then, the processor 40 converts the grey image to a black and white binary image by setting pixels within a range of a threshold value to a white color of 255 px as illustrated in FIG. 12 and setting pixels out of the region of the threshold value to a black color of 0 px based on a set threshold value (for example, 100 px to 255 px).

After the processor 40 converts the grey image to the black and white binary image, the processor 40 preprocesses the binary image by obtaining a centroid of a white area in the binary image, setting the centroid as a new reference point, and cropping the binary image based on the new reference point.

After the binary image is preprocessed in operation S50, the processor 40 calculates the thickness at the measurement position by calculating the number of pixels of the white area in the binary image and using the thickness conversion function (S60).

In this case, the thickness conversion function may be defined as a combination of a power function form and an exponential function form like Equation 1.

In addition, since an amount of transmitted light varies according to a thickness, the correction factors are set by analyzing a transmitted light image (correct image) of a sample of which an exact thickness is known and calculating the number of pixels within a range of a threshold value.

Accordingly, the processor 40 sets the correction factors of the thickness conversion function differently according to an amount of light of the light source 50 to calculate a thickness.

As described above, according to the thickness measurement apparatus for a large molded product according to the embodiment of the present invention, since the light sources 50 may move to different positions according to a product model in horizontal and vertical directions, precisely move in the x, y, and z axis directions, and emit light, and the camera for obtaining a transmitted light image may rotate in various directions and capture an image, a thickness may be measured by automatically changing a position of a large molded product formed of a light-transmitting material having any of various sizes, obtaining a transmitted light image, and analyzing image data.

According to a thickness measurement apparatus and method for a large molded product according to one aspect of the present invention, since light sources can move to different positions according to a product model in horizontal and vertical directions, precisely move in x, y, and z axis directions, and emit light, and a camera for obtaining a transmitted light image can rotate in various directions and capture an image, a thickness can be measured by automatically changing a position of a large molded product formed of a light-transmitting material having any of various sizes, obtaining a transmitted light image, and analyzing image data.

However, effects which can be achieved through the present invention are not limited to the above-described effects, and other effects which are not described above will be clearly understood by those skilled in the art from the above description of the present invention.

Although the present invention has been described with reference to embodiments illustrated in the accompanying drawings, these are merely exemplary, and it will be understood by those skilled in the art that various modifications and other equivalent embodiments are possible from the embodiments of the present invention.

Therefore, the scope of the present invention should be defined by the appended claims.

What is claimed is:

1. A thickness measurement apparatus for a large molded product, comprising:
a light source holder module which rotates a light source in 3-axis directions;
a horizontal movement module which horizontally moves the light source holder module mounted on a horizontal movement guide;
a vertical movement module which vertically moves the horizontal movement guide along a vertical movement guide; and
a processor which moves the light source to a measurement position by operating the horizontal movement module, the vertical movement module, and the light source holder module according to a measurement schedule based on the measurement position of a molded product, operates the light source, obtains a transmitted light image from a measurement surface using a camera, and calculates a thickness at the measurement position from an image obtained by preprocessing the transmitted light image.

2. The thickness measurement apparatus of claim 1, wherein the processor rotates the camera toward the measurement surface using a camera rotation module and obtains the transmitted light image of red-green-blue (RGB).

3. The thickness measurement apparatus of claim 1, wherein the processor preprocesses the transmitted light image by cropping an image of a set region in the transmitted light image based on the measurement position, converting the image to a grey image, converting the grey image to a black and white binary image based on a set threshold value, obtaining a centroid of a white area in the binary image, and cropping the image based on the centroid.

4. The thickness measurement apparatus of claim 3, wherein the processor calculates the thickness at the measurement position by converting the number of pixels of the white area using a thickness conversion function.

5. The thickness measurement apparatus of claim 4, wherein the processor sets a correction factor of the thickness conversion function to vary according to an amount of light of the light source.

6. The thickness measurement apparatus of claim 1, further comprising a fixing module of which a width and a height are adjusted and fixed to fix the molded product in a region between the horizontal movement guide and the vertical movement guide.

7. A thickness measurement method for a large molded product, comprising:
operating, by a processor, a horizontal movement module, a vertical movement module, and a light source holder module according to a measurement schedule based on a measurement position of a molded product, moving a light source to the measurement position, and operating the light source;
obtaining, by the processor, a transmitted light image from a measurement surface using a camera;
preprocessing, by the processor, the transmitted light image; and
calculating, by the processor, a thickness at the measurement position from the preprocessed image.

8. The thickness measurement method of claim 7, wherein the obtaining of the transmitted light image includes rotating, by the processor, the camera toward the measurement surface using a camera rotation module and obtaining the transmitted light image of red-green-blue (RGB).

9. The thickness measurement method of claim 7, wherein the preprocessing includes:
converting, by the processor, the transmitted light image to a grey image by cropping an image of a set region of the transmitted light image based on the measurement position;
converting, by the processor, the grey image to a black and white binary image based on a set threshold value; and
obtaining, by the processor, a centroid of a white area of the binary image and cropping the binary image based on the centroid.

10. The thickness measurement method of claim 9, wherein the calculating of the thickness includes calculating, by the processor, the thickness at the measurement position by calculating the number of pixels of the white area in the binary image and using a thickness conversion function.

11. The thickness measurement method of claim 10, wherein the calculating of the thickness includes setting, by the processor, a correction factor of the thickness conversion function to vary according to an amount of light of the light source.
